(19) United States
(12) Patent Application Publication
(10) Pub. No.: US 2026/0286019 A1
(43) Pub. Date: Sep. 24, 2026

(54) PROCESS FOR PRODUCING BRANCHED POLYOLEFIN

(71) Applicant: Dow Global Technologies LLC, Midland, MI (US)

(72) Inventors: Lixin Sun, Sugarland, TX (US); Thomas Wesley Karjala, JR., Lake Jackson, TX (US); Edmund M. Carnahan, Pearland, TX (US)

(21) Appl. No.: 19/167,229

(22) PCT Filed: Feb. 28, 2024
(86) PCT No.: PCT/US24/17675

§ 371 Date: Sep. 19, 2025

Related U.S. Application Data
(60) Provisional application No. 63/492,587, filed on Mar. 28, 2023.

(51) Int. Cl. C08F 10/02; C07F 5/06; C07F 7/00

(52) U.S. Cl. CPC C08F 10/02; C07F 5/062; C07F 7/00

(57) ABSTRACT

The present disclosure provides a process. In an embodiment, the process includes contacting, under first polymerization conditions in a first polymerization reactor at a temperature less than 150° C., a first polymerization catalyst and a first cocatalyst with (i) an ethylene monomer and an optional α-olefin comonomer, and (ii) a dual-headed aluminum-alkyl chain transfer agent. The process includes first forming one or more telechelic aluminum-terminated polymer chains and feeding the one or more telechelic aluminum-terminated polymer chains to a second polymerization reactor. The second polymerization reactor has second polymerization conditions, a second polymerization catalyst, a second cocatalyst, and a temperature from 160° C. to 250° C. The process includes contacting, in the second polymerization reactor, (iii) an ethylene monomer and an optional olefin comonomer, and (iv) the one or more telechelic aluminum-terminated polymer chains. The process includes forming an ethylene-based polymer having an I₁₀/I₂ greater than 8.0 and a vinyl content greater than 20/1,000,000 C.

### BACKGROUND

An olefin-based polymer with long chain branching (LCB) is an olefin-based polymer containing one or more side chain branches whose length is comparable to or longer than a critical entanglement length. Incorporating long chain branching (LCB) is known to enhance the processibility and increase melt strength in olefin-based polymers.

Compared with a linear olefin-based polymer having the same molecular weight, an olefin-based polymer with LCB shows higher shear sensitivity, higher zero shear viscosity, greater melt elasticity, greater impact strength, and higher melt strength (“melt strength” being the resistance to stretching during elongation of the molten olefin-based polymer). High melt strength is a desirable mechanical property in thermoforming, extrusion coating, and blow molding processes involving olefin-based polymers.

In addition, olefin-based polymer with LCB exhibits higher viscosity at low shear rate and lower viscosity at high shear rate when compared to linear olefin-based polymer having the same molecular weight. Shear thinning is advantageous in polymer processing, such as under high shear conditions.

For linear low density polyethylene (LLDPE), a common mechanism to form LCB during coordination polymerization (a form of addition polymerization mediated by transition metal catalysts) of olefin is through the insertion of vinyl-terminated polymer chains generated by thermal termination at transition metal catalyst sites. The level of LCB formed by this mechanism is typically low due to the low population of vinyl terminated polymer chains. In contrast, low density polyethylenes (LDPEs) produced by free radical polymerization are known for superior processibility due to the unique “tree-like” branch-on-branch structures. Known is the addition of α, ω-dienes, such as decadiene, during olefin polymerization to bridge two polymer chains. The α, ω-diene approach is disadvantageous because it increases the risk of gelling in the reactor system and imparts logistical burdens due to the limited availability and high cost of industrial-scale quantities of α, ω-diene. The art recognizes the need for alternative processes to produce long chain branching in olefin-based polymer. In particular a need exists for a process to produce long chain branching in olefin-based polymer (and ethylene-based polymer in particular) by way of coordination polymerization of olefins.

### SUMMARY

The present disclosure provides a process. In an embodiment, the process includes contacting, under first polymerization conditions in a first polymerization reactor at a temperature less than 150° C., a first polymerization catalyst and a first cocatalyst with (i) an ethylene monomer and an optional α-olefin comonomer, and (ii) a dual-headed aluminum-alkyl chain transfer agent. The process includes first forming one or more telechelic aluminum-terminated polymer chains and feeding the one or more telechelic aluminum-terminated polymer chains to a second polymerization reactor. The second polymerization reactor has second polymerization conditions, a second polymerization catalyst, a second cocatalyst, and a temperature from 160° C. to 250° C. The process includes contacting, in the second polymerization reactor, (iii) an ethylene monomer and an optional olefin comonomer, and (iv) the one or more telechelic aluminum-terminated polymer chains. The process includes forming an ethylene-based polymer having an I₁₀/I₂ greater than 8.0 and a vinyl content greater than 20/1,000,000 C.

### BRIEF DESCRIPTION OF THE DRAWINGS

FIG. 1 is a chart showing the chemical structures for different types of carbon-carbon double bonds (unsaturation in polymer chain) for vinylene, trisubstituted, vinyl, and vinylidene.

FIG. 2 is a schematic representation of a polymerization process in accordance with an embodiment of the present disclosure.

FIG. 3 is a schematic representation of a dual-reactor polymerization system in accordance with an embodiment of the present disclosure.

FIG. 4 is a graph showing a DMS viscosity overlay for comparative sample 6 and inventive examples 6-13.

FIG. 5 is a graph showing a DMS tan delta overlay for comparative sample 6 and inventive examples 6-13.

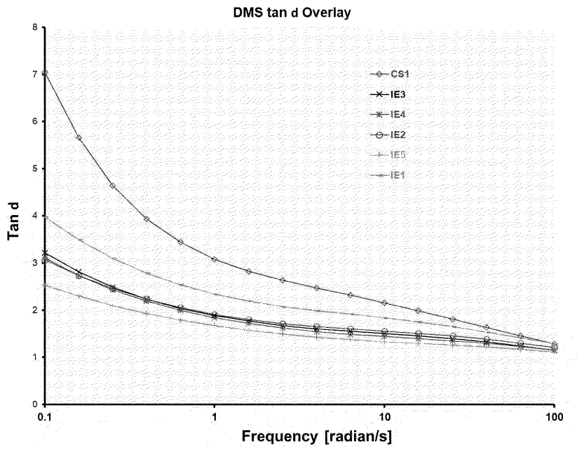

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2, or 3 to 5, or 6, or 7), any subrange between any two explicit values is included (e.g., the range 1-7 above includes the subranges of from 1 to 2; from 2 to 6; from 5 to 7; from 3 to 7; from 5 to 6; etc.).

Unless stated to the contrary, implicit from the context, all parts and percents are based on weight and all test methods are current as of the filing date of this disclosure.

An “alkyl group,” as used herein, is a saturated hydrocarbonyl group.

The terms “blend” or “polymer blend,” as used herein, is a blend of two or more polymers. Such a blend may or may not be miscible (not phase separated at molecular level). Such a blend may or may not be phase separated. Such a blend may or may not contain one or more domain configurations, as determined from transmission electron spectroscopy, light scattering, x-ray scattering, and other methods known in the art.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “ethylene-based polymer” and like terms refer to a polymer containing, in polymerized form, a majority weight percent of units derived from ethylene based on the total weight of the polymer. Nonlimiting examples of ethylene-based polymers include low density polyethylene (or “LDPE” that is ethylene homopolymer, or ethylene/α-olefin copolymer comprising at least one C₃-C₁₀ α-olefin, preferably C₃-C₄ that has a density from 0.915 g/cc to 0.940 g/cc and contains long chain branching with broad MWD, typically produced by way of high pressure free radical polymerization), linear low density polyethylene (or “LLDPE”) a linear ethylene/α-olefin copolymer containing heterogeneous short-chain branching distribution comprising units derived from ethylene and units derived from at least one C₃-C₁₀ α-olefin comonomer or at least one C₄-C₈ α-olefin comonomer, or at least one C₆-C₈ α-olefin comonomer; LLDPE is characterized by little, if any, long chain branching, in contrast to conventional LDPE; LLDPE has a density from 0.880 g/cc, or 0.890 g/cc, or 0.900 g/cc, or 0.910 g/cc, or 0.915 g/cc, or 0.920 g/cc, or 0.925 g/cc to 0.930 g/cc, or 0.935 g/cc, or 0.940 g/cc), very low density polyethylene (VLDPE), ultra low density polyethylene (ULDPE), medium density polyethylene (or “MDPE”-ethylene homopolymer, or an ethylene/α-olefin copolymer comprising at least one C₃-C₁₀ α-olefin, or a C₃-C₄ α-olefin, that has a density from 0.926 g/cc to 0.940 g/cc), high density polyethylene (or “HDPE”) is an ethylene homopolymer or an ethylene/α-olefin copolymer with at least one C₄-C₁₀ α-olefin comonomer, or C₄-C₈ α-olefin comonomer and a density from greater than 0.94 g/cc, or 0.945 g/cc, or 0.95 g/cc, or 0.955 g/cc to 0.96 g/cc, or 0.97 g/cc, or 0.98 g/cc).

A “heteroatom” is an atom other than carbon or hydrogen. The heteroatom can be a non-carbon atom from Groups IV, V, VI and VII of the Periodic Table. Nonlimiting examples of heteroatoms include: F, N, O, P, B, S, and Si.

A “hydrocarbon” is a compound containing only hydrogen atoms and carbon atoms. A “hydrocarbonyl” (or “hydrocarbonyl group”) is a hydrocarbon having a valence (typically univalent). A hydrocarbon can have a linear structure, a cyclic structure, or a branched structure

An “interpolymer” is a polymer prepared by the polymerization of at least two different monomers. This generic term includes copolymers, usually employed to refer to polymers prepared from two different monomers, and polymers prepared from more than two different monomers. e.g., terpolymers, tetrapolymers, etc.

The term “long chain branching,” “LCB” and like terms refer to a branch chain extending from the polymer backbone, the branch chain comprising more than one carbon atom. If the polymer is a copolymer (such as ethylene/α-olefin copolymer, for example), then the LCB comprises one carbon more than two carbons less than the total length of the longest comonomer copolymerized with ethylene. For example, in an ethylene/octene copolymer, the LCB is at least seven carbons atoms in length. As a practical matter, the LCB is longer than the side chain resulting from the incorporation of the comonomer into the polymer backbone. The polymer backbone of an HPLDPE comprises coupled ethylene units.

An “olefin-based polymer” or “polyolefin” is a polymer that contains more than 50 weight percent polymerized olefin monomer (based on total amount of polymerizable monomers), and optionally, may contain at least one comonomer. Nonlimiting examples of an olefin-based polymer include ethylene-based polymer or propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

### Test Methods

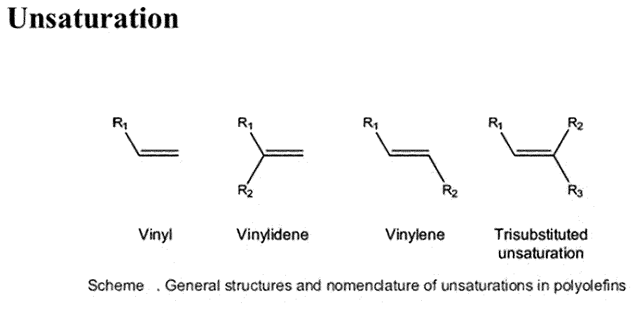

¹H NMR. ¹H nuclear magnetic resonance (¹H NMR) detects the following types of carbon-carbon double bonds (“unsaturation”) in the polymer. “Vinylene” is a carbon-carbon double bond with the formula R₁—CH═CH—R₂, wherein R₁ and R₂ each is a carbon atom or a heteroatom selected from N, O, P, B, S, and Si. “Trisubstituted” is a carbon-carbon double bond in which the doubly bonded carbons are bonded to a total of three carbon atoms and wherein R₁, R₂ and R₃ (in FIG. 1) each is a carbon atom. “Vinyl” is a carbon-carbon double bond with the formula R—CH═CH₂, wherein R is a carbon atom or a heteroatom selected from N, O, P, B, S, and Si. “Vinylidene” is a carbon-carbon double bond with the formula C═CH₂. “Total unsaturation (or “total”) is the sum of vinylene, trisubstituted, vinyl, and vinylidene in a polymer. The chemical structures for vinylene, trisubstituted, vinyl, and vinylidene are provided in FIG. 1.

Polymer samples for ¹H NMR analysis were prepared by adding 130 mg of sample to 3.25 g of 50/50 by weight tetrachlorethane-d₂/perchloroethylene with 0.001 M Cr(AcAc)₃ in a 10 mm NMR tube. The samples were purged by bubbling N₂ through the solvent via a pipette inserted into the tube for approximately 5 minutes to prevent oxidation, capped, sealed with Teflon tape. The samples were heated and vortexed at 115° C. to ensure homogeneity.

¹H NMR was performed on a Bruker AVANCE 400/600 MHz spectrometer equipped with a Bruker high-temperature CryoProbe and a sample temperature of 120° C. Two experiments were run to obtain spectra, a control spectrum to quantify the total polymer protons, and a double presaturation experiment, which suppresses the intense polymer backbone peaks and enables high sensitivity spectra for quantitation of the end-groups. The control was run with ZG pulse, 4 scans, SWH 10,000 Hz, AQ 1.64 s, D₁ 14 s. The double presaturation experiment was run with a modified pulse sequence, Ic1prf2.zz1, TD 32768, 100 scans, DS 4, SWH 10,000 Hz, AQ 1.64 s, D₁ 1 s, D₁₃ 13 s. Results are reported in the number of vinyl groups (and the number of vinylene, trisubstituted, vinylidene, and total) per 1,000,000 carbon atoms, or 1,000,000 C.

Density is measured in accordance with ASTM D792, Method B. The result is recorded in grams per cubic centimeter (g/cc).

Differential scanning calorimetry (DSC). Differential Scanning calorimetry (DSC) can be used to measure the melting, crystallization, and glass transition behavior of a polymer over a wide range of temperature. The test was executed using the DSC2500 with the refrigerator cooling system from TA Instruments. Aluminum DSC Hermetic sample pans were used, wherein 5 to 8 mg of sample was added. The tests were executed in a nitrogen environment.

In the beginning of the test, the temperature was equilibrated to 180° C. and kept isothermal for 5 minutes to remove thermal history. Next, the temperature decreased to −40° C. at a rate of 10° C./min, to determine the crystallization temperature. When the end temperature was reached, it was kept for 5 minutes. Finally, the temperature increased back to 180° C. at a rate of 10° C./min to determine the melting point of the polymer.

Triple Detector GPC (TD-GPC). The chromatographic system for the triple detector gel permeation chromatography (TD-GPC) consisted of a PolymerChar GPC-IR (Valencia, Spain) high temperature GPC chromatograph equipped with an internal IR5 infra-red detector (IR5). The autosampler oven compartment was set at 160° C. and the column compartment was set 150° C. The columns used were 4 Agilent “Mixed A” 30 cm 20-micron linear mixed-bed columns and a 20-μm pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{polyethylene} = A \times {( {M}_{polystyrene} )}^{B} \qquad ( EQ1 )$$

where M is the molecular weight, A has a value of 0.4315 and B is equal to 1.0

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{R {V}_{Peak Max}}{Peak Width a𝔱 \frac{1}{2} heiqht} )}^{2} \qquad ( EQ2 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn_{(GPC)}, MW_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ4 )$$

$${Mn}_{( GPC )} = \frac{{\sum }^{i} {IR}_{i}}{{\sum }^{i} ( {IR}_{i} / {M}_{{polyethylene}_{i}} )} \qquad ( EQ5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate (nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate (effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−1% of the nominal flowrate.

$$Flowrate ( effective ) = Flowrate ( nominal ) * ( RV ( FM Calibrated ) / RV ( FM Sample )$$

### (EQ7)

Melt flow indices (12, 110) were measured according to ASTM Method D1238. I₂ and 110 were measured at 190° C./2.16 kg and 190° C./10 kg respectively. Results are reported in grams eluted per 10 minutes, or g/10 min.

The Dynamic Mechanical Analysis (DMA) was performed using an ARES-G2 rheometer with two parallel plates, having a diameter of 25 mm. The test was performed at 190° C., using a gap of 1.8 mm with a frequency interval ranging from 0.1 to 100 rad/s, at a strain of 10%. By applying this deformation and measuring the resulting torque with the transducer, parameters such as the complex viscosity, storage and loss modulus at a certain shear were determined.

### DETAILED DESCRIPTION

The present disclosure provides a process. In an embodiment, a process is provided and includes contacting, under first polymerization conditions in a first polymerization reactor at a temperature less than 150° C., a first polymerization catalyst and a first cocatalyst with (i) an ethylene monomer and an optional α-olefin comonomer, and (ii) a dual-headed aluminum-alkyl chain transfer agent; first forming one or more telechelic aluminum-terminated polymer chains; feeding the one or more telechelic aluminum-terminated polymer chains to a second polymerization reactor having second polymerization conditions, a second polymerization catalyst, a second cocatalyst, and a temperature from 160° C. to 250° C. The process includes contacting, in the second polymerization reactor, (iii) an ethylene monomer and an optional olefin comonomer, and (iv) the one or more telechelic aluminum-terminated polymer chains; and forming an ethylene-based polymer having an I₁₀/I₂ greater than 8.0 and a vinyl content greater than 20/1,000,000 C.

The process includes contacting, under first polymerization conditions in a first polymerization reactor at a temperature less than 150° C., the first polymerization catalyst and the first cocatalyst with (i) an olefin monomer and an optional olefin comonomer, and (ii) a dual-headed-aluminum-alkyl chain transfer agent. The term “polymerization conditions,” as used herein, refers to process parameters under which ethylene (and optional olefin comonomer) are copolymerized in the presence of a catalyst system. First polymerization conditions include, for example, polymerization reactor conditions (reactor type), reactor pressure, reactor temperature, concentrations of reagents and polymer, solvent, carrier, residence time and distribution, influencing the molecular weight distribution and polymer structure. The term first polymerization conditions, as used herein, includes a polymerization temperature at a temperature less than 150° C., or from 85° C. to 150° C., or from 90° C. to 140° C., or from 100° C. to 135° C., or from 110° C. to 130° C.

In an embodiment, the first polymerization catalyst has the Formula (1)

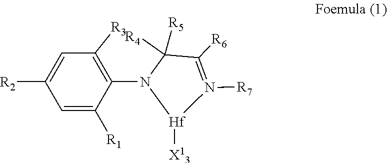

wherein X¹ each occurrence is halide, N,N-dimethylamido, or C₁-4 alkyl, and preferably each occurrence X¹ is methyl; and
R₁-R₇ each independently is hydrogen, halogen, C₁-C₂₀ alkyl, or C₆-C₂₀ aryl, or two adjacent R groups are joined together thereby forming a ring.

In an embodiment, the first polymerization catalyst has the Formula (2)

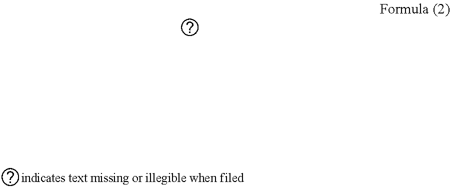

The first polymerization conditions include the provision of a first cocatalyst. Nonlimiting examples of suitable first cocatalyst include boron compounds which may be used as an activating cocatalyst in the preparation of the improved catalysts of this disclosure include the tri-substituted ammonium salts such as trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-dimethylanilinium n-butyltris(pentafluorophenyl)borate, N,N-dimethylanilinium benzyltris(pentafluorophenyl)borate, N,N-dimethylanilinium tetrakis(4-(t-butyldimethylsilyl)-2,3,5,6 tetrafluorophenyl)borate, N,N-dimethylanilinium tetrakis(4-(triisopropylsilyl)-2,3,5,6-tetrafluorophenyl)borate, N,N-dimethylanilinium pentafluorophenoxytris(pentafluorophenyl)borate, N,N-diethylanilinium tetrakis(pentafluorophenyl)borate, N,N-dimethyl-2,4,6-trimethylanilinium tetrakis(pentafluorophenyl)borate, dimethyloctadecylammonium tetrakis(pentafluorophenyl)borate, methyldioctadecylammonium tetrakis(pentafluorophenyl)borate; a number of dialkyl ammonium salts such as: di-(i-propyl)ammonium tetrakis(pentafluorophenyl)borate, methyloctadecylammonium tetrakis(pentafluorophenyl)borate, methyloctadodecylammonium tetrakis(pentafluorophenyl)borate, and dioctadecylammonium tetrakis(pentafluorophenyl)borate; various tri-substituted phosphonium salts such as: triphenylphosphonium tetrakis(pentafluorophenyl)borate, methyldioctadecylphosphonium tetrakis(pentafluorophenyl)borate, and tri(2,6-dimethylphenyl)phosphonium tetrakis(pentafluorophenyl)borate; di-substituted oxonium salts such as: diphenyloxonium tetrakis(pentafluorophenyl)borate, di(o-tolyl)oxonium tetrakis(pentafluorophenyl)borate, and di(octadecyl)oxonium tetrakis(pentafluorophenyl)borate; and di-substituted sulfonium salts such as: di(o-tolyl) sulfonium tetrakis(pentafluorophenyl)borate, and methylcotadecylsulfonium tetrakis(pentafluorophenyl)borate.

An (i) an ethylene monomer and (ii) an optional olefin comonomer are polymerized under the first polymerization conditions. Nonlimiting examples of suitable olefin comonomer include α-olefins having from 3 carbon atoms to 30 carbon atoms, or from 3 carbon atoms to 20 carbon atoms, or from 3 carbon atoms to 10 carbon atoms, or from 4 carbon atoms to 8 carbon atoms. In an embodiment, the olefin comonomer is present and the olefin comonomer is selected from propylene, butene, hexene, and octene, or is selected from butene, hexene, and octene.

In an embodiment, the process includes contacting, under polymerization conditions in the first polymerization reactor at a temperature less than 150° C., the first polymerization catalyst and the first cocatalyst with only (i) ethylene monomer and (ii) one or more C₃-C₈ α-olefin comonomers and to the exclusion of diene, and/or to the exclusion of branching agent.

The process includes contacting, under the first polymerization conditions at a temperature less than 150° C., the first polymerization catalyst and the first cocatalyst with (i) an olefin monomer and an optional olefin comonomer, and (ii) an a dual-headed aluminum-alkyl chain transfer agent. A “chain transfer agent,” as used herein, refers to a compound that is capable of exchanging a polymeryl group (an alkyl group, for example) on the chain transfer agent with a growing polymer chain on the catalyst, the exchange resulting in termination of the polymer chain growth under the first polymerization conditions. A “dual-headed aluminum-alkyl chain transfer agent,” as used herein is a chain transfer agent that is a compound having the Formula A,

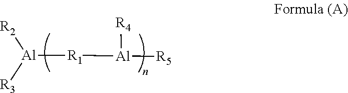

wherein
   n is a number from 1 to 100;
   R₁ is a divalent linear, branched, or cyclic C₄ to C₁₀₀ hydrocarbyl group that optionally
   includes at least one heteroatom and that is aliphatic or aromatic; and
   R₂, R₃, R₄ and R₅ each is independently hydrogen, a substituted or unsubstituted alkyl group, or a substituted or unsubstituted aryl group. R₂ and R₃, R₄ and R₅ may unite with each other to form a divalent C₄-C₁₀₀ ring. Nonlimiting examples of dual-headed aluminum-alkyl chain transfer agents include Structures (B), (C), (D), (E) shown below:

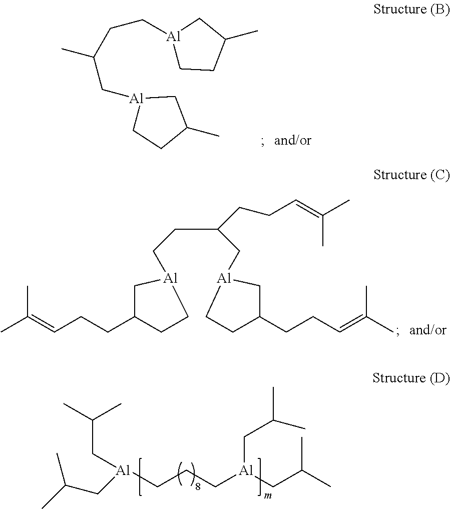

wherein m is an integer from 1 to 100, or from 1 to 10; and/or

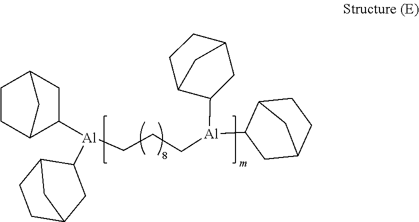

wherein m is an integer from 1 to 100, or from 1 to 10.

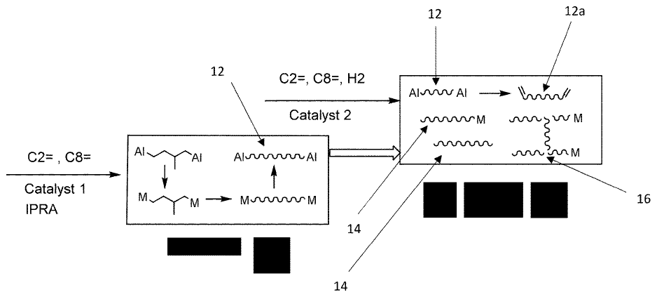

FIG. 2 is a schematic representation of the present process. Under the first polymerization conditions in the first polymerization reactor (“Reactor-1”) at a temperature less than 150° C. (or 135° C.), contact occurs between the first polymerization catalyst, the first cocatalyst, the ethylene monomer (and optional olefin comonomer) or octene, and the dual-headed aluminum-alkyl chain transfer agent. The alkyl groups on aluminum transfer to the catalyst, grow into polymer chains from both ends, and transfer back to aluminum to form one or more (or a plurality of) telechelic aluminum-terminated polymer chains 12. A “telechelic aluminum-terminated polymer chain,” as used herein is a polymer or a prepolymer chain having at least two ends and capable of entering into further polymerization or other reactions through its reactive end-groups, the polymer or prepolymer containing aluminum metal on at least two ends of the chain.

The second polymerization catalyst has the resilience for olefin polymerization at high temperature, or a temperature from 160° C. to 250° C. In an embodiment, the second polymerization catalyst has the Formula (3)

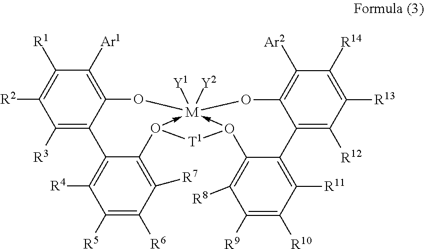

wherein
M is titanium, zirconium, or hafnium;
each Y¹ and Y² is independently selected from the group consisting of (C₁-C₄₀)hydrocarbyl, (C₁-C₄₀)trihydrocarbylsilylhydrocarbyl, halogen, alkoxide, or amine, or two Y groups together are a divalent hydrocarbylene, hydrocarbadiyl or trihydrocarbylsilyl group;
each Ar¹ and Ar² independently is selected from the group consisting of (C₆-C₄₀)aryl, substituted (C₆-C₄₀)aryl, (C₃-C₄₀)heteroaryl, and substituted (C₃-C₄₀)heteroaryl;
T¹ independently at each occurrence is a divalent bridging group of from 2 to 20 carbon atoms, optionally containing heteroatoms including Si, Ge, O, N, S and P; and
each R¹, R², R³, R⁴, R⁵, R⁶, R⁷, R⁸, R⁹, R¹⁰, R¹¹, R¹², R¹³, and R¹⁴ independently is selected from the group consisting of hydrogen, a halogen, (C₁-C₄₀)hydrocarbyl, substituted (C₁-C₄₀)hydrocarbyl, (C₁-C₄₀)heterohydrocarbyl, substituted (C₁-C₄₀)heterohydrocarbyl, (C₆-C₄₀)aryl, substituted (C₆-C₄₀)aryl, (C₃-C₄₀)heteroaryl, and substituted (C₃-C₄₀)heteroaryl, and nitro (NO₂).

In an embodiment, the second polymerization catalyst has the Formula (4)

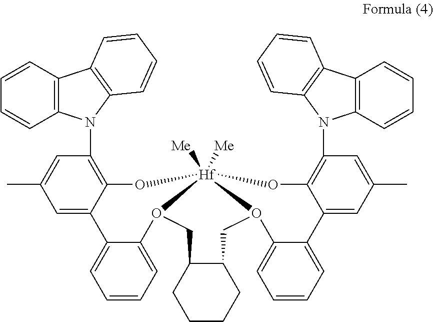

The second polymerization conditions include the provision of a second cocatalyst. Nonlimiting examples of suitable second cocatalyst include the cocatalysts suitable for use in the first polymerization catalyst.

The (i) ethylene monomer and (ii) an optional olefin comonomer are polymerized under the second polymerization conditions. Nonlimiting examples of suitable olefin comonomer include α-olefins having from 3 carbon atoms to 30 carbon atoms, or from 3 carbon atoms to 20 carbon atoms, or from 3 carbon atoms to 8 carbon atoms, or from 4 carbon atoms to 8 carbon atoms. In an embodiment, the olefin comonomer is present and the olefin comonomer is selected from propylene, 1-butene, 1-hexene, and 1-octene, or is selected from 1-butene, 1-hexene, and 1-octene.

The process includes feeding, or otherwise transferring the one or more telechelic aluminum-terminated polymer chains 12 (from the first polymerization reactor) to a second polymerization reactor. The telechelic aluminum-terminated polymers 12 are fed directly to, or directly into, the second polymerization reactor. The second polymerization reactor has second polymerization conditions, a second polymerization catalyst, a second cocatalyst, and a temperature from 160° C. to 250° C. The term “second polymerization conditions,” as used herein, refers to process parameters under which ethylene (and optional olefin comonomer) are copolymerized in the second polymerization reactor in the presence of a second catalyst system, the second polymerization conditions different than the first polymerization conditions. In particular, the second polymerization conditions include, for example, parameters such as polymerization reactor conditions (reactor type), reactor pressure, reactor temperature, concentrations of reagents and polymer, solvent, carrier, residence time and distribution, wherein one or more parameters in the second polymerization conditions are different than the respective parameter in the first polymerization conditions. The second polymerization conditions influence the molecular weight distribution and polymer structure. The term second polymerization conditions, as used herein, includes a polymerization temperature from 160° C. to 250° C., or from 180° C. to 230° C., or from 190° C. to 220° C.

Referring to FIG. 2, in the second polymerization reactor (“Main Reactor” in FIG. 2) under the second polymerization conditions at the temperature from 160° C. to 250° C. (or 190° C.), the process includes contacting the plurality of aluminum-terminated polymer chains 12 with ethylene monomer (and optional olefin comonomer, or octene) and forming one or more growing polymer chains 14. Where the first polymerization catalyst effectively chain transfers with the dual-headed aluminum-alkyl chain transfer agent, the second polymerization catalyst provides (1) the resilience for polymerization at high temperature (160° C.-250° C.) and (2) the ability to incorporate vinyl-terminated polymer chains.

In an embodiment, ethylene (“C2=”) and the optional olefin comonomer is present and is octene (“C8=”), as shown in FIG. 2. The growing polymer chains 14 are ethylene/octene copolymer. As the polymer chains 14 are growing, simultaneously or substantially simultaneously, the plurality of aluminum-terminated polymer chains 12 are converted into one or more (or a plurality of) polymeryl chains, or polymeryl dienes 12a. Bounded by no particular theory, it is believed that under the second polymerization conditions (and the second polymerization temperature from 160° C. to 250° C.) aluminum-terminated polymer chains 12 undergo beta-hydride elimination to form the dual-vinyl-terminated polymeryl chains 12a (or “polymeryl dienes”). In the second polymerization reactor and under the second polymerization conditions, the vinyl-terminated-polymeryl chains 12a incorporate, or otherwise insert, into the growing polymer chains 14, thereby forming olefin-based polymer having H-shaped long-chain branching 16. In an embodiment, the growing polymer chains are ethylene/octene copolymer and the vinyl-terminated-polymeryl chains 12a incorporate, or otherwise insert, into the growing ethylene/octene copolymer chains to form ethylene/octene copolymer having H-shaped long-chain branching.

In an embodiment, the process includes contacting, under first polymerization conditions in a first polymerization reactor at a temperature from 120° C. to 150° C. (or 135° C.), a first polymerization catalyst with the structure of Formula (1) and a first cocatalyst with
(i) an ethylene monomer and a C₃-C₈ α-olefin comonomer (octene, for example), and
(ii) a dual-headed aluminum-alkyl chain transfer agent (IPRA for example);
first forming one or more telechelic aluminum-terminated polymer chains;
feeding the one or more telechelic aluminum-terminated polymer chains to a second polymerization reactor having second polymerization conditions, a second polymerization catalyst with the structure of Formula (2), a second cocatalyst, and a temperature from 180° C. to 230° C. (or 190° C.);
contacting, in the second polymerization reactor,
(iii) ethylene monomer and a C₃—C α-olefin comonomer (octene, for example), and
(iv) the one or more telechelic aluminum-terminated polymer chains; and forming an ethylene-based polymer having
(i) an I₁₀/I₂ from 8.5 to 20.0, or from 9.0 to 15.0, or from 9.3 to 13.2; and/or (ii) a vinyl content from 25/1,000,000 C to 100/1,000,000 C, or from 30/1,000,000 C to 90/1,000,000 C, or from 35/1,000,000 C to 80/1,000,000 C; and/or
(iii) an Mw/Mn from 2.4 to 4.0, or from 2.5 to 3.5, or from 2.6 to 3.4.

By way of example, and not limitation, some embodiments of the present disclosure are described in detail in the following examples.

### EXAMPLES

Table 1 below provides catalysts, co-catalysts, and di-aluminum-alkyl chain transfer agents used to prepare Comparative Samples (CS) A-C and Inventive Examples (IE) 1-5.

TABLE 1
Materials

| | |
|---|---|
| Catalyst 1 (first polymerization catalyst Formula (2)) 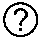 | Hafnium, [N-[6-(butylimino-.kappa.N)-1-cyclohexen-1- yl]-2,6-bis(1-methylethyl)benzeneaminato.kappa. N]trimethyl- |
| Catalyst 2 (second polymerization catalyst Formula (4)) 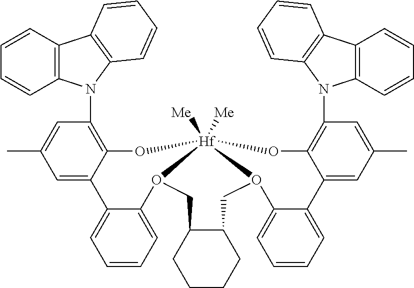 | Hafnium, [[rel-2′,2′′′-[(1R,2R)-1,2- cyclohexanediylbis(methyleneoxy-.kappa.O)]bis[3-(9H- carbazol-9-yl)-5-methyl[1,1′-biphenyl]-2-olato-. kappa.O]](2-)]dimethyl-, |
| Cocatalyst 1 | Amines, bis(hydrogenated tallow alkyl)methyl, |
| R₂MeNH⁺ (R = hydrogenated tallow alkyl) | tetrakis(pentafluorophenyl)borate(1-) |
| 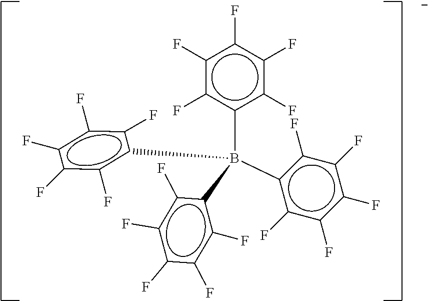 | |
| Cocatalyst 2 (MMAO-3A) 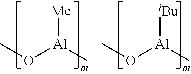 | Modified methylalumoxane (MMAO) Type 3A (no further purification performed) (Akzo Nobel) |
| Dual-headed aluminum-alkyl chain transfer agent chain transfer agent | Isoprenylaluminum (IPRA) |
| 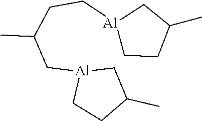 | |

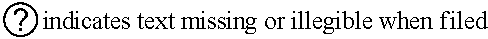

### Polymerization of Ethylene/Octene Copolymer Having LCB

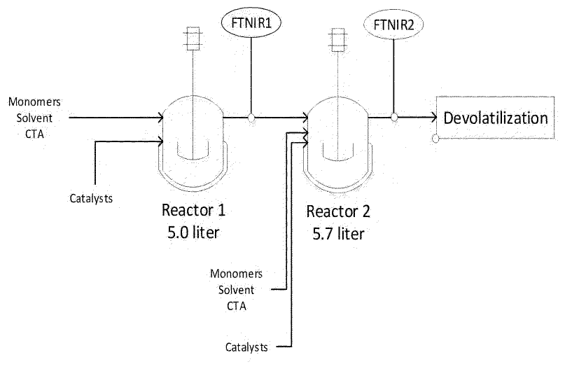

Ethylene-based polymer having H-shaped long-chain branching was synthesized using a first polymerization reactor that is a well-mixed, high pressure, autoclave reactor and a second polymerization reactor that is a well-mixed, high pressure, autoclave reactor, the first polymerization reactor and the second polymerization reactor configured in series (hereafter interchangeably referred to as “dual reactor system”) as shown in FIG. 3. Purified solvent Isopar-E, ethylene monomer and octene comonomer were mixed with chain transfer agent (CTA) and injected into the first polymerization reactor that is 5 liters in volume.

First polymerization catalyst (catalyst 1), borate activator, dual-headed aluminum-alkyl chain transfer agent (IPRA), ethylene monomer and octene comonomer were introduced to the first polymerization reactor to produce telechelic aluminum-terminated polymer chains.

The telechelic aluminum-terminated polymer chains were transported to the second polymerization reactor. To the second polymerization reactor second polymerization catalyst (catalyst 2), borate activator, ethylene, octene and hydrogen were fed to produce the growing chains of ethylene/octene copolymer. The telechelic aluminum-terminated polymer chains undergo beta-hydride elimination at high temperature in the second polymerization reactor (190° C.) to form divinyl polymeryl chains, or polymeryl dienes.

The divinyl polymeryl chains were incorporated to bridge growing ethylene/octene polymer chains to form ethylene/octene copolymer having long-chain branching, and ethylene/octene copolymer having H-shaped branching.

The effluent from the second polymerization reactor is composed of polymer, solvent, and unreacted reagents such as monomer, comonomer, hydrogen, aluminum-alkyl chain transfer agent (IPRA, and catalyst components). The effluent from the second polymerization reactor is sent to devolitization equipment for removal of solvent and unreacted monomers. Either water or isopropyl alcohol (IPA) is added to the effluent to neutralize the remaining catalyst components and metal alkyls.

In comparative sample 1 (CS1), the first polymerization reactor was not used. CS1 polymer was produced only in the second polymerization reactor using catalyst 2. IE1-5 were produced using the “dual reactor system” described above. Polymerization conditions are provided in Tables 2 and 3 below where “R₁” is the first polymerization reactor and “R₂” is the second polymerization reactor.

TABLE 2A
First polymerization reaction conditions

| | R1 | | | | | | | R1 | | | R1 CTA | | |
|---|---|---|---|---|---|---|---|---|---|---|---|---|---|
| | Production | R1 | R1 | R1 | R1 | | | Cocat | | | Solution | R1 | R1 |
| | Rate | Solvent | Ethylene | Octene | Hydrogen | | Cocat | 1:Catalyst | R1 | R1 CTA | Concen- | Temper- | Ethylene |
| | Split, | feed, | feed, | feed, | feed, | R1 | 1 | Molar | CTA | Flow, | tration, | ature, | Conversion, |
| Sample | wt % | kg/hr | kg/hr | kg/hr | SCCM | cat | name | ratio | Name | g/h | mmol/kg | C. | % |
| CS1 | 0.0 | 5.22 | 0.00 | 0.00 | 0 | None | None | 0 | | 0 | 0 | | 0% |
| IE1 | 5.1 | 7.26 | 0.37 | 0.00 | 0 | 1 | RIBS-2 | 1.20 | IPRA | 115.00 | 80.00 | 135 | 79% |
| IE2 | 9.2 | 9.69 | 0.59 | 0.00 | 0 | 1 | RIBS-2 | 1.20 | IPRA | 209.99 | 80.00 | 135 | 82% |
| IE3 | 9.7 | 9.41 | 0.59 | 0.18 | 0 | 1 | RIBS-2 | 1.20 | IPRA | 209.99 | 80.00 | 135 | 83% |
| IE4 | 14.5 | 9.52 | 0.59 | 0.18 | 0 | 1 | RIBS-2 | 1.20 | IPRA | 209.98 | 80.00 | 135 | 82% |
| IE5 | 18.3 | 14.22 | 0.86 | 0.00 | 0 | 1 | RIBS-2 | 1.20 | IPRA | 300.02 | 80.00 | 135 | 82% |

TABLE 2B
Second polymerization reaction conditions

| | R2 | | | | | | | | | | | |
|---|---|---|---|---|---|---|---|---|---|---|---|---|
| | Production | R2 | R2 | R2 | R2 | | | | | | R2 | R2 |
| | Rate | Solvent | Ethylene | Octene | Hydrogen | R2 | R2 | R2 | R2 | R2 | Temper- | Ethylene |
| | Split, | feed, | feed, | feed, | feed, | Cata- | Cocat1 | Cocat1:Catalyst | Cocat2 | Cocat2:Catalyst | ature, | Conversion, |
| | wt % | kg/hr | kg/hr | kg/hr | SCCM | lyst | Name | Molar ratio | Name | Molar ratio | C. | % |
| CS1 | 100.0 | 22.12 | 5.30 | 0.67 | 430.25 | 2 | 0 | 1.19 | MMAO- | 0.9 | 190 | 95% |
| | | | | | | | | | 3A | | | |
| IE1 | 94.9 | 18.59 | 5.40 | 0.76 | 755.15 | 2 | RIBS-2 | 1.20 | MMAO- | 5.0 | 190 | 94% |
| | | | | | | | | | 3A | | | |
| IE2 | 90.8 | 15.95 | 4.69 | 0.85 | 798.92 | 2 | RIBS-2 | 1.20 | MMAO- | 7.5 | 190 | 94% |
| | | | | | | | | | 3A | | | |
| IE3 | 90.3 | 16.18 | 4.70 | 0.66 | 770.33 | 2 | RIBS-2 | 1.20 | MMAO- | 4.4 | 190 | 94% |
| | | | | | | | | | 3A | | | |
| IE4 | 85.5 | 10.17 | 2.96 | 0.45 | 730.87 | 2 | RIBS-2 | 1.20 | MMAO- | 5.6 | 190 | 92% |
| | | | | | | | | | 3A | | | |
| IE5 | 81.7 | 10.13 | 3.05 | 0.82 | 919.98 | 2 | RIBS-2 | 1.21 | MMAO- | 4.0 | 190 | 91% |
| | | | | | | | | | 3A | | | |

TABLE 2C
Ethylene/octene polymer properties

| | Melt | | | | | | Unsaturation unit/1,000,000 carbon | | | | |
|---|---|---|---|---|---|---|---|---|---|---|---|
| Sample | Index | I₁₀/I₂ | Density | Mn | Mw | Mw/Mn | vinylene | trisubstituted | vinyl | vinylidene | Total |
| CS1 | 1.1 | 7.7 | 0.9205 | 38,822 | 88,552 | 2.28 | 4 | 1 | 12 | 1 | 19 |
| IE1 | 1.11 | 9.3 | 0.9215 | 32,719 | 85,194 | 2.6 | 5 | 1 | 35 | 3 | 44 |
| IE2 | 0.92 | 11 | 0.9193 | 30,211 | 85,525 | 2.83 | 6 | 2 | 49 | 4 | 61 |
| IE3 | 0.84 | 10.8 | 0.92 | 31,428 | 87,146 | 2.77 | 7 | 1 | 49 | 6 | 64 |
| IE4 | 0.86 | 11.6 | 0.9197 | 29,114 | 85,105 | 2.92 | 7 | 1 | 69 | 7 | 84 |
| IE5 | 0.92 | 13.2 | 0.9214 | 25,960 | 86,833 | 3.34 | 7 | 2 | 77 | 5 | 91 |

Inventive Examples (IE) IE1-5 were produced with increasing amount of 1^{st} reactor product, telechelic aluminum-terminated polymer chains, feeding to the 2^{nd} reactor. The 110/12 ratio increased indicating formation of branched polymers. The telechelic aluminum-terminated polymer chains turned into polymer dienes in the 2^{nd} reactor as evidenced by the significantly higher amount of vinyl groups in IE1-IE5 samples.

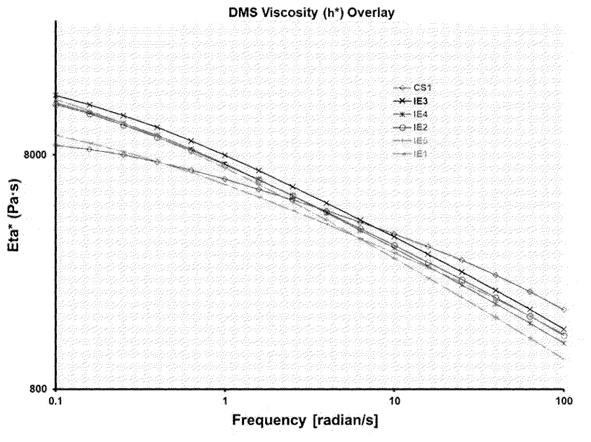

DMS analysis of the products is shown in FIG. 4. The inventive polymers produced from IE1-5 show significantly different rheological behavior, e.g., higher shear thinning and lower tan-delta values, as compared to the linear polymer produced from CS1. This is consistent to the behavior of branched polymers.

It is specifically intended that the present disclosure not be limited to the embodiments and illustrations contained herein, but include modified forms of those embodiments including portions of the embodiments and combinations of elements of different embodiments as come within the scope of the following claims.

1. A process comprising:
contacting, under first polymerization conditions in a first polymerization reactor at a temperature less than 150° C., a first polymerization catalyst and a first cocatalyst with
(i) an ethylene monomer and an optional α-olefin comonomer, and
(ii) a dual-headed aluminum-alkyl chain transfer agent;
first forming one or more telechelic aluminum-terminated polymer chains;
feeding the one or more telechelic aluminum-terminated polymer chains to a second polymerization reactor having second polymerization conditions, a second polymerization catalyst, a second cocatalyst, and a temperature from 160° C. to 250° C.;
contacting, in the second polymerization reactor,
(iii) an ethylene monomer and an optional olefin comonomer, and
(iv) the one or more telechelic aluminum-terminated polymer chains; and
forming an ethylene-based polymer having an 110/12 greater than 8.0 and a vinyl content greater than 20/1,000,000 C.

2. The process of claim 1 wherein the contacting in the second polymerization reactor comprises
forming one or more growing polymer chains;
converting the one or more dual-headed aluminum-terminated polymer chains into one or more divinyl polymeryl chains;
incorporating the one or more divinyl polymeryl chains into the growing polymer chain; and
forming an ethylene-based polymer having an 110/12 greater than 8.0 and a vinyl content greater than 20/1,000,000 C.

3. The process of claim 1 wherein the first polymerization catalyst has the structure of 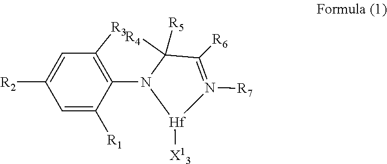
wherein X¹ each occurrence is halide, N,N-dimethylamido, or C₁₋₄ alkyl; and
R₁-R₇ each independently is hydrogen, halogen, C₁-C₂₀ alkyl, or C₆-C₂₀ aryl, or two adjacent R groups are joined together thereby forming a ring.

4. The process of claim 1 wherein the first polymerization catalyst has the structure of Formula (2)

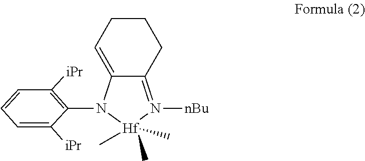

5. The process of claim 1 wherein the di-aluminum-alkyl chain transfer agent has a structure selected from the group consisting of 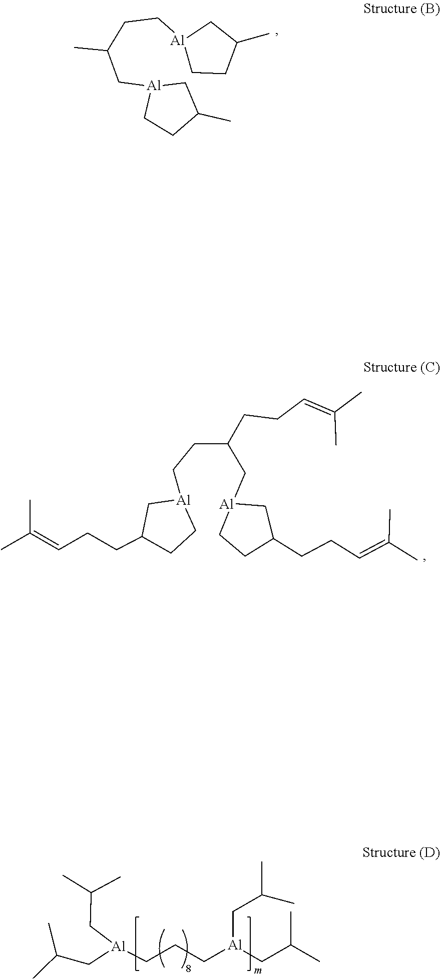
wherein m is an integer from 1 to 100, 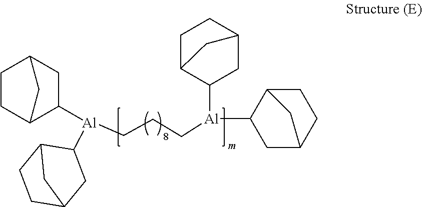
wherein m is an integer from 1 to 100, and
combinations thereof.

6. The process of claim 1 wherein the second polymerization catalyst has the structure of Formula (3) 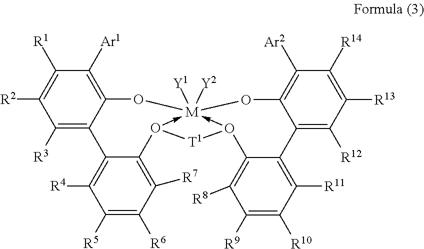
wherein
M is titanium, zirconium, or hafnium;
each Y¹ and Y² is independently selected from the group consisting of (C₁-C₄₀)hydrocarbyl, (C₁-C₄₀)trihydrocarbylsilylhydrocarbyl, halogen, alkoxide, or amine, or two Y groups together are a divalent hydrocarbylene, hydrocarbadiyl or trihydrocarbylsilyl group;
each Ar¹ and Ar² independently is selected from the group consisting of (C₆-C₄₀)aryl, substituted (C₆-C₄₀)aryl, (C₃-C₄₀)heteroaryl, and substituted (C₃-C₄₀)heteroaryl;
T¹ independently at each occurrence is a divalent bridging group of from 2 to 20 carbon atoms, optionally containing heteroatoms including Si, Ge, O, N, S and P; and
each R₁, R₂, R₃, R₄, R₅, R₆, R₇, R₈, R₉, R₁₀, R₁₁, R₁₂, R₁₃, and R₁₄ independently is selected from the group consisting of hydrogen, a halogen, (C₁-C₄₀)hydrocarbyl, substituted (C₁-C₄₀)hydrocarbyl, (C₁-C₄₀)heterohydrocarbyl, substituted (C₁-C₄₀)heterohydrocarbyl, (C₆-C₄₀)aryl, substituted (C₆-C₄₀)aryl, (C₃-C₄₀)heteroaryl, and substituted (C₃-C₄₀)heteroaryl, and nitro (NO₂).

7. The process of claim 1 wherein the second polymerization catalyst has the structure of Formula (4)

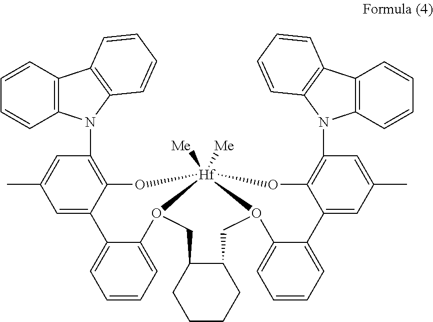

8. The process of claim 1 wherein the optional α-olefin comonomer is present and is an C₄-C₈ α-olefin comonomer, the process comprising forming an ethylene/C₄-C₈ α-olefin copolymer having
(i) an I₁₀/I₂ from 8.5 to 20.0, and
(ii) a vinyl content from 25/1,000,000 C to 100/1,000,000 C.
